(19) United States
(12) Patent Application Publication
(10) Pub. No.: US 2009/0011890 A1
(43) Pub. Date: Jan. 8, 2009

(54) Locking differential including disengagement retaining means

(76) Inventor: James R. Bawks, Harrison Township, MI (US)

Correspondence Address: LAUBSCHER & LAUBSCHER, P.C., 1160 SPA ROAD, SUITE 2B, ANNAPOLIS, MD, 21403, US

(21) Appl. No.: 11/825,358

(22) Filed: Jul. 7, 2007

(51) Int. Cl. F16H 48/06; F16D 21/08; F16H 48/20

(52) U.S. Cl. 475/231; 192/49; 192/53.4; 192/70.22; 74/650

(57) ABSTRACT

A locking differential includes a pair of annular clutch members that are normally displaced apart to effect engagement between clutch teeth on the remote ends of the clutch members and corresponding gear teeth on the adjacent ends of a pair of side gears between which the clutch members are colinearly arranged. When one output shaft overruns the other by a predetermined amount, the clutch member associated with the overrunning output shaft is disengaged from its associated side gear. A retaining device retains the clutch members in the disengaged condition until the overrunning condition is terminated. In one embodiment, the retaining device is a cam arm and follower pin arrangement that is connected between the clutch members and operates in conjunction with a pair of friction rings. In a second embodiment, the retaining device comprises a pair of holdout rings that operate between the clutch members and the side gears.

### BACKGROUND OF THE INVENTION

1. Field of the Invention

A locking differential includes a pair of annular clutch members that are normally displaced apart to effect engagement between clutch teeth on the remote ends of the clutch members and corresponding gear teeth on the adjacent ends of a pair of side gears between which the clutch members are colinearly arranged. When one output shaft overruns the other by a predetermined amount, the clutch member associated with the overrunning output shaft is disengaged from its associated side gear. A retaining device retains the clutch members in the disengaged condition until the overrunning condition is terminated. In one embodiment, the retaining device is a cam arm and follower pin arrangement that is connected between the clutch members and operates in conjunction with a pair of friction rings. In a second embodiment, the retaining device comprises a pair of holdout rings that operate between the clutch members and the side gears.

2. Description of the Related Art

Locking differentials for motor vehicles are well known in the patented prior art, as evidenced, for example, by the patents to Schou U.S. Pat. No. 4,498,355, Zentmyer U.S. Pat. No. 5,413,015, Lewis U.S. Pat. No. 2,555,044, and Dissett U.S. Pat. No. 5,715,744, among others. In these known differentials, when the rotational velocity of one of the driven output shafts exceeds that of the other output shaft above a predetermined value, such as occurs during the turning of the vehicle, the overrunning shaft is automatically disengaged from the power train as long as the overrunning condition exists.

One drawback of the known differentials is the chattering of the clutch teeth during the engagement and disengagement that occurs when a clutch member is disengaged from the associated side gear. This results in tooth wear at the tips of the clutch teeth on the clutch and side gear members, which could possibly result in the failure of the differential.

The present invention was developed to provide an improved locking differential that avoids the above and other drawbacks of the known differentials.

### BRIEF SUMMARY OF THE INVENTION

Accordingly, a primary object of the present invention is to provide a locking differential including retaining means for positively retaining the clutch member associated with an overrunning output shaft in the disengaged condition as long as the overrunning condition exists. In a first embodiment, the retaining means comprise cam means connected between the two clutch members. In a second embodiment, the retaining means comprise a pair of holdout rings that are selectively operable between the clutch members and their associated side gears, respectively. In each case, the retaining means is rotatably operated from an axially displaced intermediate condition to a final retaining condition by friction drag means.

According to a more specific object of the invention, the cam means includes a cam arm that is fixed at one end to one of the clutch members, said cam arm containing at its other end a generally T-shaped recess for receiving a cam follower pin that extends radially outwardly from the other clutch member, thereby to positively retain the overrunning clutch in the disengaged condition. In this embodiment, the friction drag means comprises a pair of resilient split friction rings that are respectively arranged concentrically between annular spacer members pinned to the side gears, and the inner circumferential surfaces of counterbores contained in the remote ends of the clutch members. Friction ring pins prevent rotational movement of the friction rings relative to their associated spacer members, and integral annular ribs on the friction rings cooperate with corresponding grooves contained in the clutch members, thereby to prevent relative axial displacement of the friction rings.

According to another object of the invention, the retaining means comprises a pair of holdout rings that connected for angular displacement relative to the clutch members, which holdout rings have radially outwardly flange portions that carry a plurality of axially extending lugs adjacent the side gears, such that when one of the clutch members is in the disengaged condition upon the overrunning of the associated output shaft, the associated holdout ring is slightly angularly displaced so that the lugs engages the tips of the teeth of the side gears, thereby to positively retain the clutch member associated with the overrunning shaft in the disengaged condition. In this embodiment, the friction drag effect is provided by resiliently outwardly biased segments of the body portion of each holdout ring.

### BRIEF DESCRIPTION OF THE DRAWINGS

Other objects and advantages of the invention will become more apparent from a study of the following specification, when viewed in the light of the accompanying drawings, in which:

FIGS. 1 and 2 are sectional and side elevation views, respectively, of a locking differential of the prior art;

FIG. 3 is a longitudinal sectional view of a first embodiment of the improved locking differential of the present invention,

FIG. 4 is a sectional view taken along the line 4-4 of FIG. 3, and

FIG. 5 is a left hand end view of the differential of FIG. 3;

FIG. 6 is a sectional view taken along line 6-6 of FIG. 7, and

FIG. 7 is a detailed view of the cam and pin arrangement of FIG. 5 when in the normal locking condition;

FIGS. 8-10 are front, side and rear views, respectively, of one of the side gears of FIG. 3, and

FIG. 11 is a sectional view taken along line 11-11 of FIG. 8;

FIGS. 12 and 13 are side and end views, respectively, of one of the helical compression springs of FIG. 3;

FIGS. 14-17 are front, side and rear views, respectively, of one of the clutch members of FIG. 3, and FIG. 17 is a sectional view taken along line 17-17 of FIG. 16;

FIGS. 18 and 19 are left hand end and side elevation views, respectively, of the spring cap member of FIG. 3;

FIG. 20 is a sectional view of the annular spacer member taken along line 20-20 of FIG. 21, and

FIG. 21 is a right hand end view of the spacer member;

FIGS. 22 and 23 are left hand end and side elevation views, respectively, of the spring pin;

FIG. 24 is a sectional view of the friction ring taken along line 24-24 of FIG. 25, and

FIG. 25 is a right hand end view of the friction ring;

FIG. 26 is a sectional view of the cam arm taken along line 26-26 of FIG. 27, and

FIG. 27 is a top plan view of the cam arm;

FIG. 28 illustrates the cam arm and pin means when in the retaining disengaged condition;

FIG. 29 is a further sectional view corresponding to FIG. 3;

FIG. 30 is a sectional view of a second embodiment of the invention, and

FIG. 31 is a corresponding section view taken at right angles to FIG. 30,

FIG. 32 and 33 are end views of the clutch member and the side gear, respectively, and

FIG. 34 is an end view of the other end of a modified version of the clutch member of FIG. 32;

FIG. 35 is an end view of one end of the holdout ring,

FIG. 36 is a sectional view taken along line 36-36 of FIG. 35, and

FIG. 37 is an end view of the other end of the holdout ring; and

FIGS. 38-40 are schematic detailed views illustrating the operation of the locking differential of FIGS. 30 and 31 when in the normal driving condition, with one output shaft in the overrunning condition, and with the other output shaft in the over running condition, respectively.

### DETAILED DESCRIPTION OF THE INVENTION

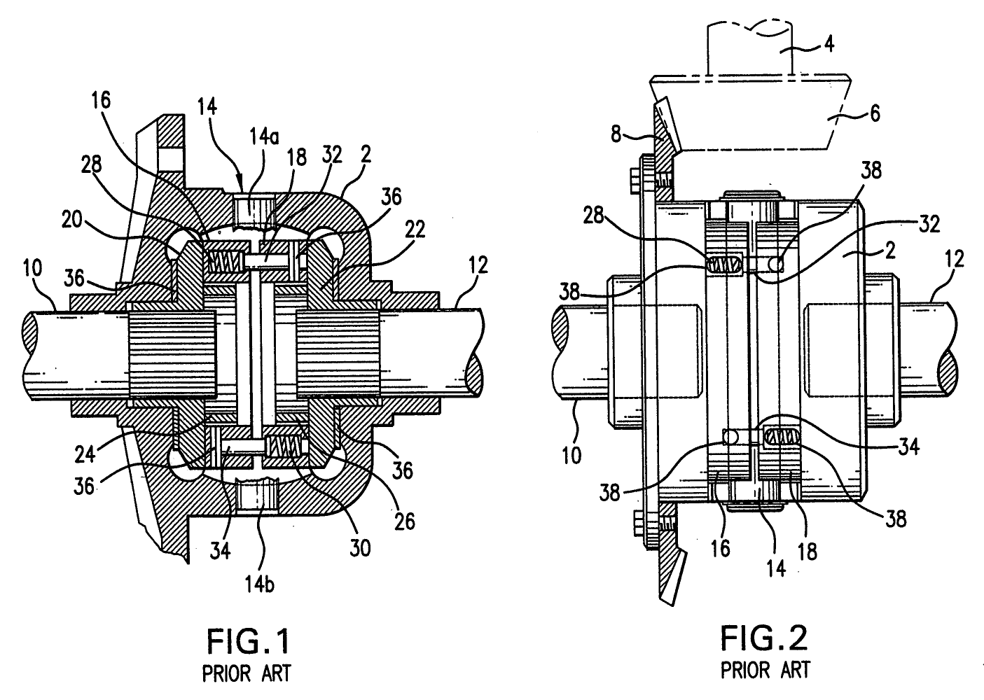

Referring first to FIGS. 1 and 2, as illustrated and described in the prior Dissett U.S. Pat. No. 5,715,733, the disclosure of which is incorporated herein, the known locking differential includes an outer housing 2 that is rotatably driven from the drive shaft 4 via pinion 6 and ring gear 8. A pair of output shafts are normally rotatably driven at the same speed by the housing via transverse drive rod 14 having end portions 14a and 14b supported in corresponding openings contained in the housing; a pair of annular clutch members 16 and 18 the adjacent faces of which contain diametrically extending grooves that receive the drive rod; and a pair of side gears 20 and 22 that are non-rotatably splined to the output shafts 10 and 12, respectively. The clutch members are mounted for axial sliding displacement on annular spacer members 24 and 26, which clutch members are normally biased apart by compression springs 28 and 30 that react on spring pins 32 and 34, respectively, thereby to effect locking engagement between circular arrangements of clutch teeth on the clutch members and corresponding circular arrangements of clutch teeth on the side gears, respectively. A plurality of support washers 36 are provided for reducing friction and wear between the rotating components. Access openings 38 are provided in the clutch members to afford access to the compression springs and pins.

As is known in the locking differential art, the output shafts are normally driven at the same rotational velocity. In the event that the rotational velocity of one output shaft exceeds that of another by a given value, as might occur during a turn, for example, the cooperation between the drive rod 14 and the wall of the groove contained in the clutch member associated with the overrunning output shaft, together with the com-out configuration of the clutch teeth and the side gear teeth, causes the clutch member to be axially displaced in a direction to disengage the clutch teeth thereof from the corresponding clutch teeth of the associated side gear, thereby to place the overrunning shaft in a free-wheeling condition. When the rotational velocity of the overrunning shaft is reduced to that of the other output shaft, the associated clutch member is spring-biased toward its initial engaged condition with the associated side gear, whereupon both output shafts are again driven at the same rotational velocity by the drive shaft 4.

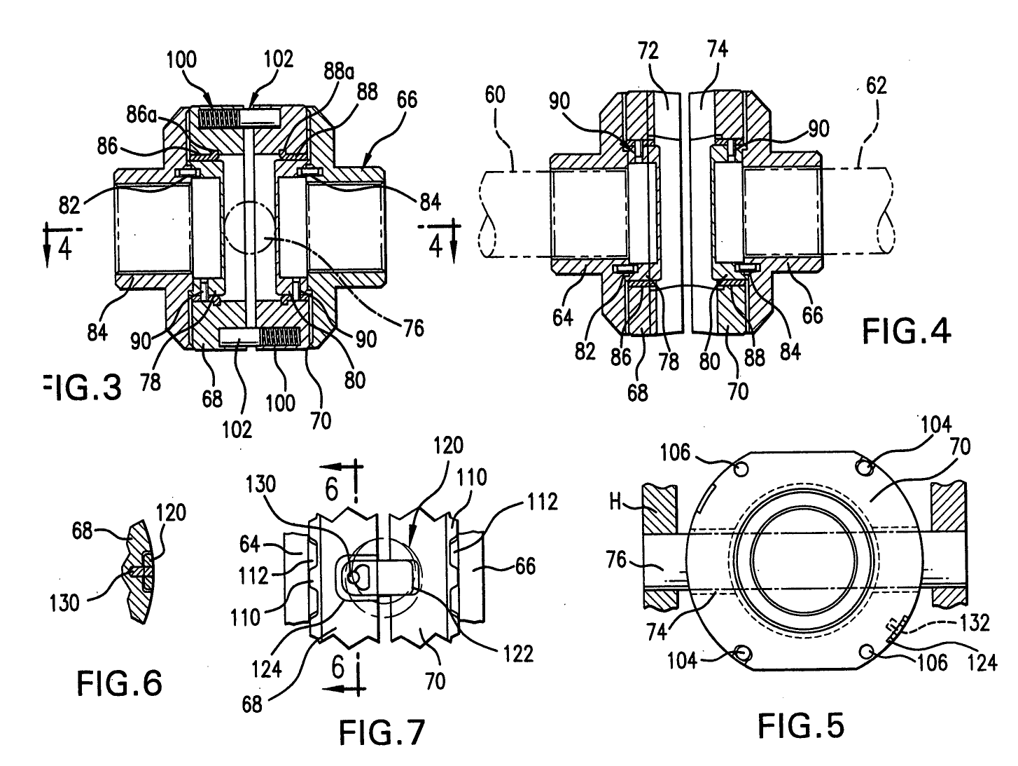

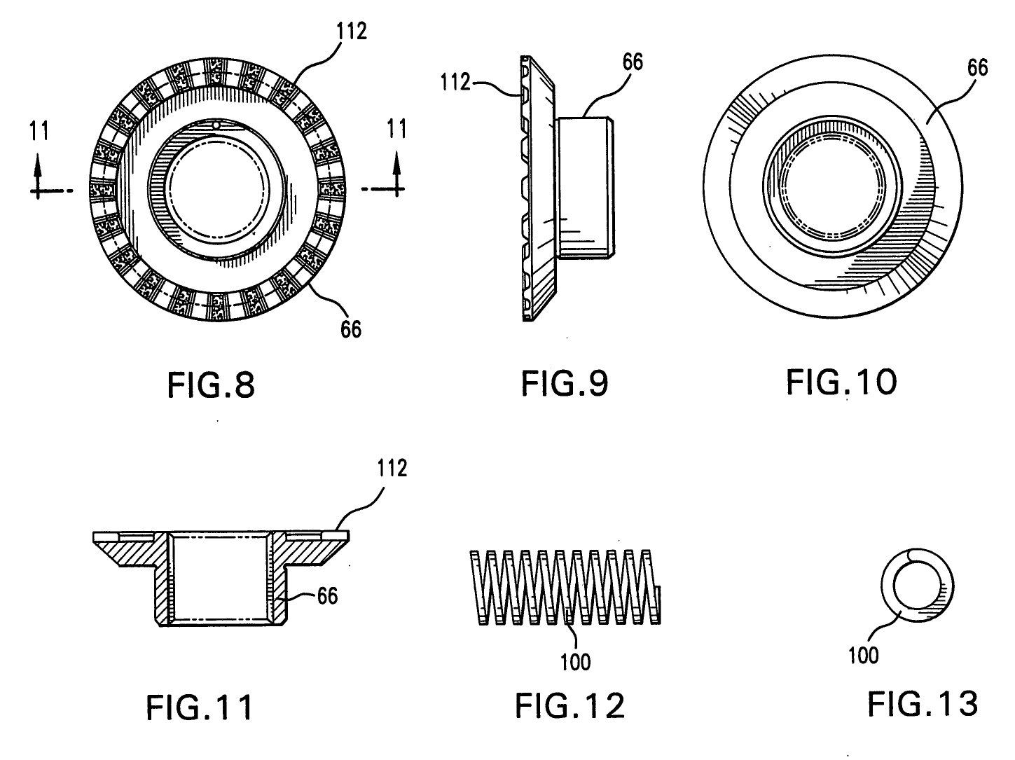

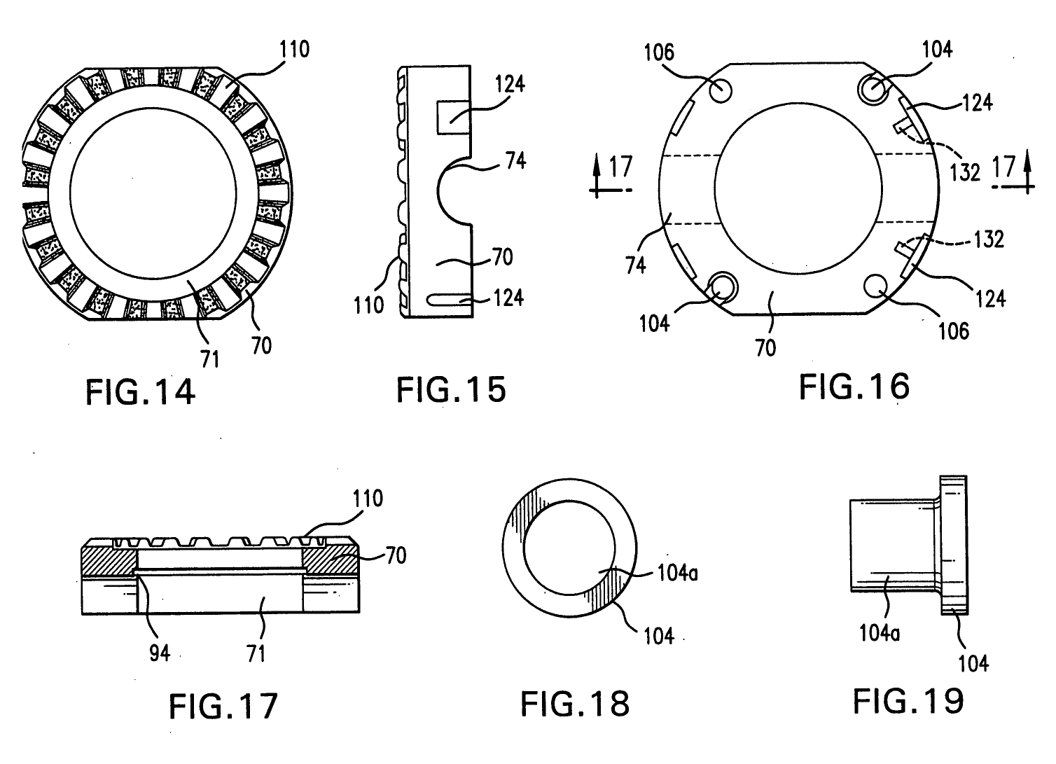

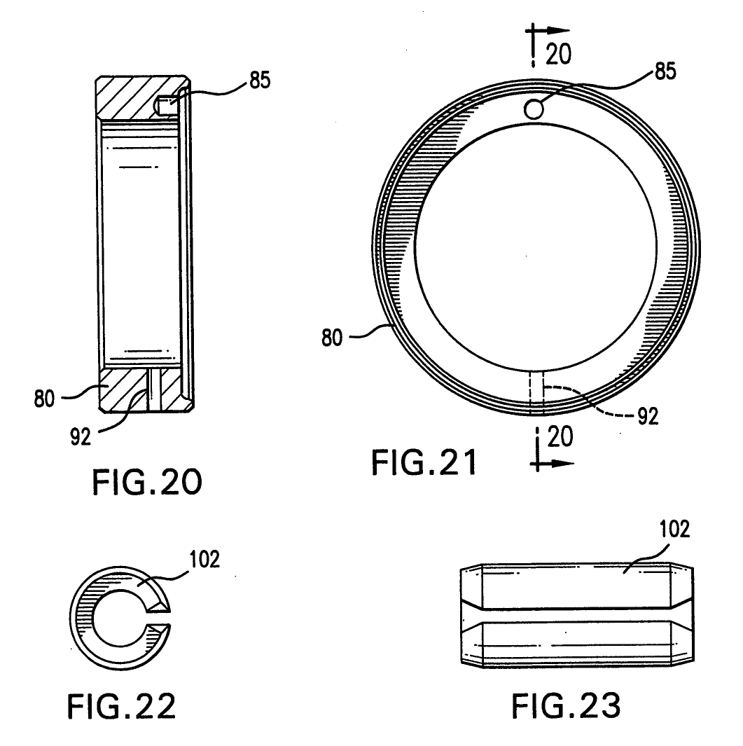

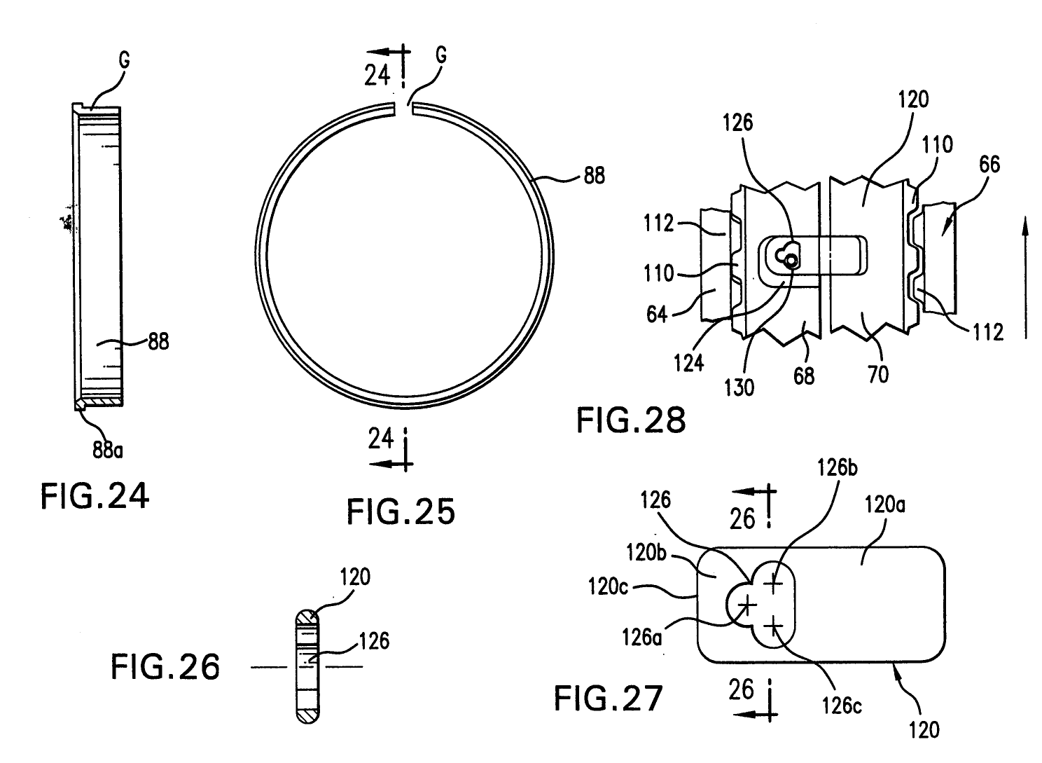

Referring now to FIGS. 3, 4, and 29, according to the present invention, the output shafts 60 and 62 are non-rotatably splined to the colinearly-arranged axially-spaced annular side gears 64 and 66 the adjacent faces of which are provided with a circular arrangement of side gear teeth 112 (FIG. 8) that normally are in engagement with a corresponding circular arrangement of clutch teeth 110 (FIG. 14) on the remote ends of the clutch members 68 and 70 that are colinearly arranged between the side gears. The adjacent faces of the clutch members contain diametrically-extending drive grooves 72 and 74 that receive the diametrically-extending drive rod 76 the ends of which are supported by the housing H (FIG. 5). The remote ends of the clutch members contain counterbores 71 (FIGS. 14 and 17) that receive annular spacer members 78 and 80 that are colinearly arranged relative to the side gears 64 and 66 and to which they are non-rotatably connected by the spacer pins 82 and 84, respectively, that extend axially from bores 85 (FIGS. 20 and 21) contained in the remote ends of the spacer members. Arranged concentrically between the spacer members and the clutch members are a pair of resilient split friction rings 86 and 88 that are resiliently biased radially outwardly toward frictional engagement with the inner circumferential surfaces of counterbores contained in the remote ends of the clutch members 68 and 70, respectively. Friction ring pins 90 extend radially outwardly from radial bores 92 (FIG. 20) contained in the spacer members 78 and 80, which friction pins extend into the gaps G (FIG. 25) of the split friction rings 86 and 88, thereby to prevent the rotation of the friction rings relative to the spacer members 78 and 80, respectively. The split friction rings are provided on their outer circumferential surfaces with integral ribs 86a and 88a that respectively extend radially outwardly into corresponding grooves 94 (FIG. 17) contained in the inner circumferential surfaces of the clutch members 68 and 70, thereby to prevent axial displacement of the friction rings relative to their associated clutch members.

The clutch members 68 and 70 are normally biased apart by compression springs 100 that react with first ends of limit pins 102 via spring caps 104 having body portions 104a (FIG. 19) that extend concentrically within the adjacent ends of the associated compression springs. The compression springs 100 are supported at one end within the oversize bores 104 (FIG. 5) contained in the opposed faces of the clutch members. Similarly, the limit pins 102 are supported at their other ends within bores 106 also contained in the clutch member opposed faces. As shown in FIGS. 14, 15 and 17, the clutch members are provided at one end with a circular arrangement of clutch teeth 110 that are normally in driving engagement with a corresponding circular arrangement of side gear teeth 112 (FIGS. 8, 9 and 10) on the side gears 64 and 66.

Referring now to FIGS. 6 and 7, in accordance with a characterizing feature of the present invention, cam arm and follower pin means are provided for maintaining in a disengaged condition the clutch member associated with an output shaft having a rotational velocity that exceeds that of the other output shaft by a predetermined value, as occurs, for example, during the turning operation of a vehicle. To this end, a rigid generally-rectangular cam arm 120 is secured at a first end 120a (FIG. 27) within a recess 122 contained in the outer peripheral surface of the clutch member 70. The second end 120b of the cam arm slidably extends into a corresponding recess 124 contained in the outer peripheral surface of the other clutch member 68. This second cam arm end contains a generally T-shaped cam opening 126 that receives a cam follower pin 130 that extends radially outwardly from a radially-inwardly extending bore 132 (FIGS. 5 and 16) contained in one or more of the recesses 124 provided in the outer circumferential surface of the clutch member.

As best shown in FIG. 27, the cam opening 126 has a first recess 126a adjacent the free extremity 120c of the cam member, and second and third recesses 126b and 126c contained in a plane that extends transversely of the axis of rotation of the output shafts, which plane is spaced axially inwardly of the first recess 126a.

### Operation

In operation, during normal operation of the vehicle (FIG. 29), the output shafts 60 and 62 are driven at the same rotational velocity from the drive shaft via the pinion and ring gears (not shown), housing H (FIG. 5), drive rod 76, clutch members 68 and 70, and side gears 64 and 66. Assuming that the drive rod 76 is driven in the direction shown by the arrow, the clutch members 68 and 70 are displaced outwardly by the driving torque as shown by the arrows, thereby effecting engagement between the clutch teeth 110 of the clutch members and the side gear teeth 112 of the side gears, as shown in FIG. 7. Cam pin 130 is positioned in the locking recess 126a of the cam opening 126 contained in the cam arm 120, and the clutch members 68 and 70 are locked together to prevent any relative angular displacement therebetween.

In the event that the rotational velocity of one output shaft exceeds that of the other above a predetermined amount (as indicated by the arrow in FIG. 28), the drive rod 76 is displaced up the wall of the corresponding groove 74, and the clutch member 70 associated with the overrunning side gear 66 splined to the overrunning output shaft is cammed out by the cooperation between the side gear teeth and the clutch teeth, and is axially displaced toward the other clutch member, thereby to effect disengagement of the clutch teeth 110 from the side gear clutch teeth 112. Cam follower pin 130 is now axially displaced within the opening 126 to an intermediate released position between the second and third positions 126b and 126c. Owing to the frictional drag produced by the friction rings 86 and 88, the clutch members are relatively slightly rotatably angularly displaced, as limited by the limit pins 102, thereby to cause the cam pin 130 to enter retaining recess 126c. The clutch members 68 and 70 is then retained in the disengaged condition as long as the output shaft overrunning condition exists. When the rotational velocity of the overrunning shaft is reduced to that of the other output shaft, the clutch members are rotationally returned by frictional drag to their initial relative positions. Owing to the force of the driving rod 76 and the biasing force produced by the compression springs 100, the clutch members are axially displaced apart toward the initial driving condition of FIG. 7, whereupon the cam pin 130 is returned to the cam locking recess 126a. Of course, in the event that the other output shaft was to be in an overrunning condition, the operation would be reversed and the cam follower pin 130 in the retaining condition would be contained in the recess 126b.

In this embodiment, the drive tooth height on the clutch teeth on the clutch and side gear members may be increased to prevent tooth tip interference with the root of the mating side gear teeth, and to prevent compressive loading at the face of the drive teeth.

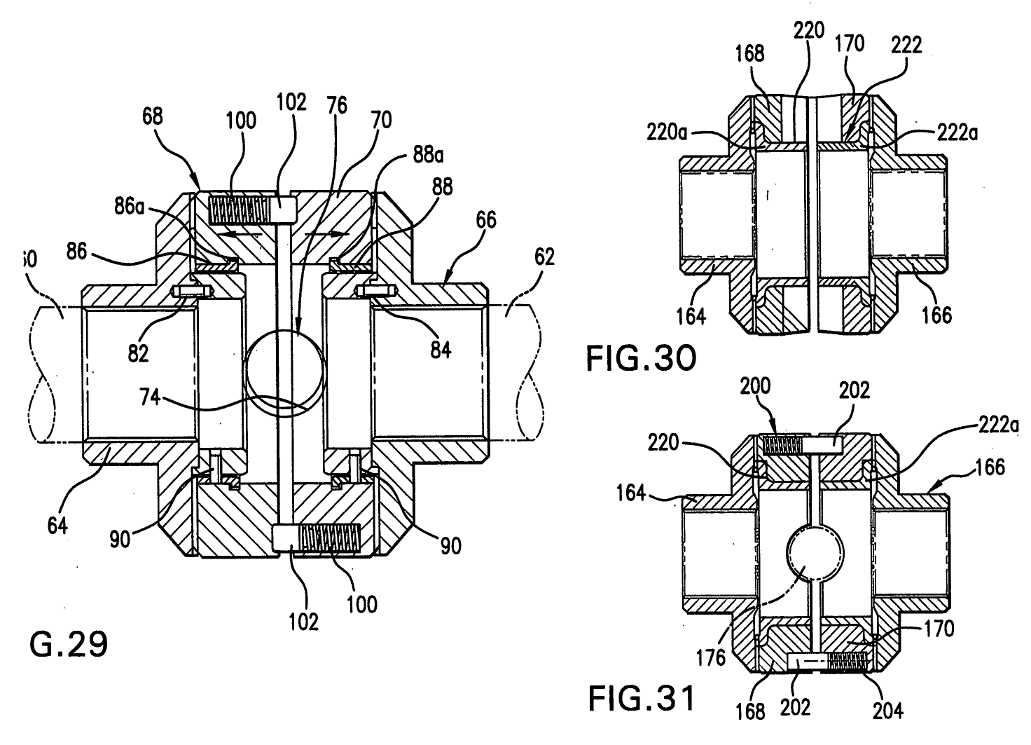

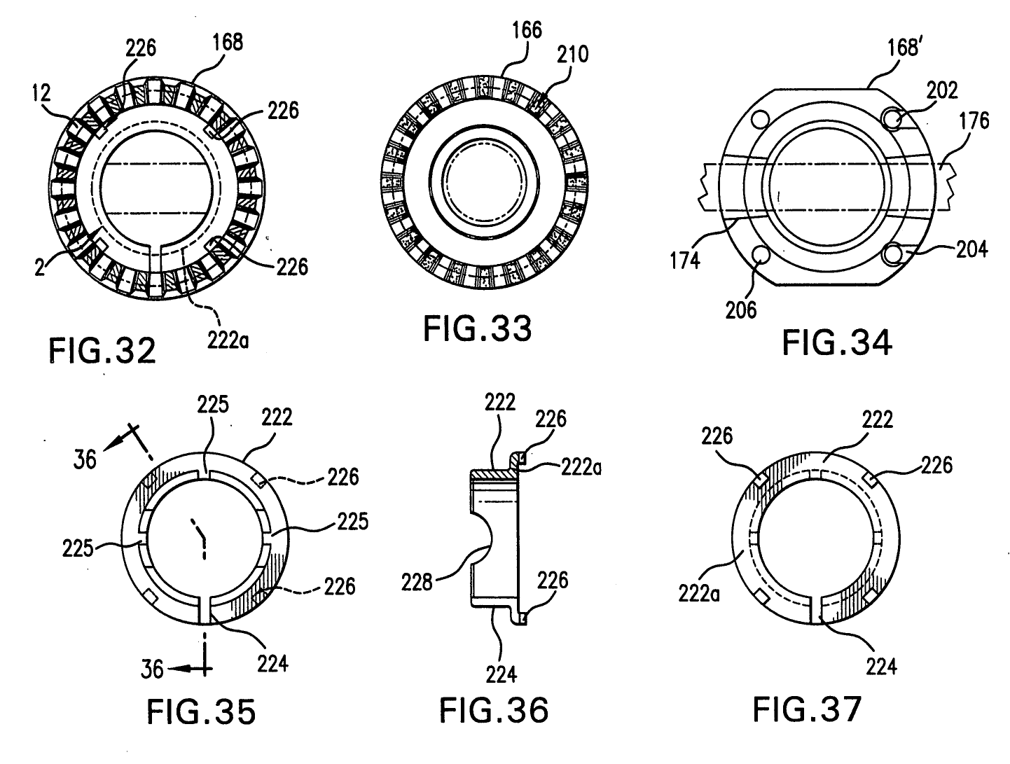

Referring now to FIGS. 30 and 31, according to a second embodiment of the invention, the retaining means includes a pair of annular resilient holdout rings 220 and 222 arranged concentrically within the clutch members 168 and 170, respectively. The holdout rings, which are axially split to define a gap 224, include tubular body portions that are provided at their remote ends with outwardly directed integral flange portions 220a and 222a that extend within corresponding counterbores contained in the outermost remote end walls of the clutch members, respectively. On their remote end surfaces, the flange portions are provided with a circular arrangement of axially projecting lugs 226. The body portion of each holdout ring contains a plurality of longitudinal slots 225 that define a plurality of resilient body segments that are biased radially outwardly into frictional engagement with the inner circumferential surface of the associated clutch member. At their adjacent ends, the holdout rings contain grooves 228 that receive the drive rod 176.

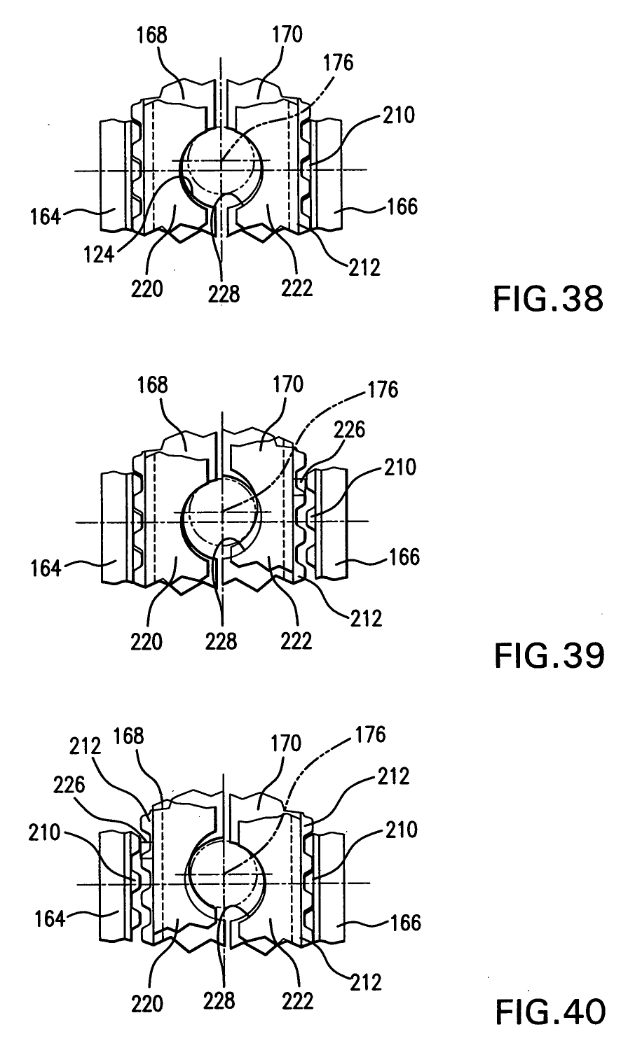

As shown in FIG. 38, when the vehicle is driven in the forward direction, the driving torque is equally distributed and both output shafts are driven at the same rotational velocity by the clutch members 168 and 170 and the side gears 164 and 166. In this condition, the lugs on the holdout rings extend between the side gear teeth 210. In the event of a left turn, the side gear 166 and the clutch member 170 speed up relative to the drive rod 176, and the clutch teeth 212 are disengaged from the side gear teeth 210. The holdout ring 222 is frictionally dragged relative to the clutch member 170 to the illustrated holdout position in which the lugs 226 engage the tips of the side gear teeth 210, thereby to positively maintain the clutch member in the disengaged condition as long as the overrunning condition exists. When the turn is completed, the components are returned to their initial condition of FIG. 28.

In the event of a right hand turn (FIG. 40), the clutch teeth 212 of the clutch member 168 are disengaged from the side gear teeth 210 of the side gear 164, and the holdout ring 220 is frictionally dragged and angularly rotated to the illustrated holdout position in which the holdout ring lugs 226 engage the tips of the side gear teeth 210. Thus, the clutch member 168 is positively maintained in the disengaged condition by the holdout ring 220 as long as the overrunning condition exists.

In this embodiment, to obtain the proper holdout ring operation, the lengths of the side gear teeth are preferably longer and extend radially inwardly to a greater extent than clutch teeth 212.

While in accordance with the provisions of the Patent Statutes, we have illustrated and described the best form and embodiments of the invention now known to us, it is apparent that changes may be made without deviating from the inventive concepts set forth above.

1. A locking differential for an automotive vehicle having a drive shaft, and a pair of colinearly-arranged axially-spaced output shafts that drive the wheels of the vehicle, comprising:
(a) a cylindrical housing (H) adapted for rotation about a given axis of rotation, said housing containing a chamber having a pair of end walls containing a pair of aligned output shaft openings arranged coaxially with said axis of rotation for receiving the adjacent ends of said output shafts, respectively;
(b) a pair of annular axially-spaced side gears rotatably mounted in said chamber adjacent and colinear with said output shaft openings for non-rotatable splined connection with the output shafts, respectively, said side gears having adjacent spaced faces each provided with a circular arrangement of side gear teeth;
(c) clutch means including a pair of axially-spaced annular clutch members arranged colinearly between said side gears, said clutch members having remote faces each including a circular arrangement of clutch teeth opposite said side gear teeth, respectively, each of said clutch members being axially displaceable relative to the associated side gear between an engaged position in which said side gear and said clutch teeth are in engagement, and a disengaged position in which said side gear teeth and said clutch teeth are disengaged;
(d) limiting means affording limited relative angular rotational displacement between said clutch members;
(e) spring means normally biasing said clutch members axially apart toward said engaged positions relative to said side gears, respectively;
(f) drive means for driving said clutch members by said housing, said drive means comprising a drive pin extending diametrically between said clutch members, said drive rod having a pair of end portions that extend within corresponding openings contained in said housing, said drive rod having an intermediate portion that extends within drive grooves contained in the adjacent faces of said clutch members, the cross-sectional configuration of said drive grooves and the relative configurations of the clutch teeth and the side gear teeth being such that when the rotational velocity of a first output shaft exceeds that of the other output shaft above a given value, the clutch member associated with the overrunning output shaft is axially displaced toward said disengaged position; and
(g) retaining means for retaining the clutch member associated with the overrunning first output shaft in the disengaged position as long as the overrunning condition exists,
(1) said retaining means being axially operable from a normal first condition to an intermediate condition upon axial displacement of said overrunning clutch member from the engaged position toward the disengaged condition;
(2) said retaining means being rotationally operable from said intermediate condition to a retaining condition; and
(h) friction drag means for rotating said retaining means from said intermediate condition to said retaining condition.

2. A locking differential as defined in claim 1, wherein said retaining means is connected between said clutch members.

3. A locking differential as defined in claim 1, wherein said retaining means is connected between at least one of said clutch members and the associated side gear.

4. A locking differential as defined in claim 2, wherein said retaining means comprises:
(3) a cam arm having a first end portion connected with a first one of said clutch members adjacent the outer circumferential surface thereof, said cam arm having a second end portion extending axially toward the other clutch member, said second arm portion containing a cam opening; and
(4) a cam follower pin extending radially outwardly from the other clutch member into said cam opening;
(5) said cam opening being generally T-shaped and including;
(a) a first cam operating recess receiving said cam follower pin when said retaining means is in said first condition;
(b) a second cam operating recess receiving said cam follower pin when said cam means is in said second lockout condition, said second cam recess being axially and rotationally displaced in one direction relative to said first recess; and
(c) a third cam operating recess axially and rotationally displaced in the opposite direction relative to said first recess for receiving, thereby to receive said cam follower pin, thereby to place said cam means in the retaining condition when said other output shaft is in an overrunning condition relative to said first output shaft.

5. A locking differential as defined in claim 4, wherein one of said clutch members has an outer circumferential surface containing a first external recess within which said cam arm first end portion is secured, the other of said clutch members containing a corresponding second external recess into which said second cam arm end portion extends, said cam follower pin being mounted in said second external recess.

6. A locking differential as defined in claim 5, and further including:
(i) a pair of annular spacer members having first ends that are arranged concentrically within counterbores contained in the remote ends of said clutch members, respectively, said spacer members having second ends that abut said side gears, respectively; and
(j) spacer pin means connecting each of said spacer members against rotation relative to the associated side gear, respectively.

7. A locking differential as defined in claim 6, wherein said friction drag means comprises:
(1) a pair of generally annular split friction rings concentrically mounted between said spacer members and the inner circumferential surfaces of the associated clutch members, respectively, each of said friction rings being radially biased outwardly toward frictional engagement with the associated clutch member;
(2) friction pin means connecting each of said friction rings against rotation relative to the associated spacer ring, said friction pin means including a friction pin that extends radially outwardly from the associated spacer member into the gap defined by the split contained in the associated friction ring; and
(3) means preventing axial displacement each of said friction rings relative to the associated clutch member, respectively, said displacement preventing means including integral external annular ribs provided on the outer circumferential surfaces of said friction rings extending outwardly within corresponding annular grooves contained in the inner counterbore surfaces of clutch members, respectively.

8. A locking differential as defined in claim 3, wherein said retaining means comprises:
(3) a pair of annular resilient holdout rings mounted concentrically within each of said clutch members, respectively;
(a) each of said holdout rings containing throughout its length an axial slit;
(b) said holdout ring being biased radially outwardly toward frictional engagement with the inner circumferential surface of the associated clutch member, thereby to define said friction drag means;
(c) said holdout rings including body portions having at their remote ends radially outwardly extending flange portions that extend within corresponding counterbores contained in the remote end surfaces of said clutch members, respectively; and
(d) a plurality of circumferentially-spaced locking lugs mounted on and extending axially from the remote faces of said holdout ring flange portions;
(e) each of said holdout rings being angularly displaceable relative to the associated clutch member between an initial position in which said lugs extend between the teeth of the associated side gear when said clutch member and said side gear are in the engaged condition, and a retaining position in which the lugs engage the tips of the teeth of the associated side gear when said clutch member and said side gear are in the disengaged condition.

9. A locking differential as defined in claim 8, wherein the length of the teeth of said side gears is greater than the length of the clutch members, the teeth of said side gears extending radially inwardly to a greater extent than the teeth of the clutch members.

10. A locking differential as defined in claim 9, wherein said body portion of each of said holdout rings consists of a plurality of segments defined by a plurality of longitudinally extending slots, said body segments being radially biased into engagement with the inner circumferential surface of the associated spacer member.

11. A locking differential as defined in claim 10, wherein the adjacent ends of said holdout rings contain a pair of diametrically arranged drive recesses that receive said drive rod

12. A locking differential for an automotive vehicle having a drive shaft, and a pair of colinearly-arranged axially-spaced output shafts that drive the wheels of the vehicle, comprising:
(a) a cylindrical housing (H) adapted for rotation about a given axis of rotation, said housing containing a chamber having a pair of end walls containing a pair of aligned output shaft openings arranged coaxially with said axis of rotation for receiving the adjacent ends of said output shafts, respectively;
(b) a pair of annular axially-spaced side gears (64, 66) rotatably mounted in said chamber adjacent and colinear with said output shaft openings for non-rotatable splined connection with the output shafts, respectively, said side gears having adjacent spaced faces each provided with a circular arrangement of side gear teeth (112);
(c) a pair of axially-spaced annular clutch members (68, 70) arranged colinearly between said side gears, said clutch members having remote faces each including a circular arrangement of clutch teeth (110) opposite said side gear teeth, respectively, each of said clutch members being axially displaceable relative to the associated side gear between an engaged position in which said side gear and said clutch teeth are in engagement, and a disengaged position in which said side gear teeth and said clutch teeth are disengaged;
(d) a limit pin arrangement (102, 104, 106) affording limited relative angular rotational displacement between said clutch members;
(e) a spring arrangement (100) normally biasing said clutch members axially apart toward said engaged positions relative to said side gears, respectively;
(f) a drive rod (76) extending diametrically between said clutch members, said drive rod having a pair of end portions that extend within corresponding openings contained in said housing, said drive rod having an intermediate portion that extends within drive grooves (74) contained in the adjacent faces of said clutch members, the cross-sectional configuration of said drive grooves and the relative configuration of said clutch teeth and said side gear teeth being such that when the rotational velocity of a first output shaft exceeds that of the other output shaft above a given value, the clutch member associated with the overrunning output shaft is axially displaced toward said disengaged position; and
(g) a retaining cam arrangement (120, 130) connected between said clutch members for retaining the clutch member associated with the overrunning first output shaft in the disengaged position as long as the overrunning condition exists,
(1) said retaining cam arrangement being axially operable from a normal first condition to an intermediate condition upon axial displacement of said overrunning clutch member from the engaged position toward the disengaged position; and
(2) said retaining cam arrangement being rotationally operable from said intermediate condition to a retaining condition; and
(h) a friction drag device (86, 88) for rotating said retaining cam arrangement toward said retaining condition.

13. A locking differential as defined in claim 12, wherein said retaining cam arrangement comprises:
(3) a cam arm (120) having a first end portion connected with a first one of said clutch members adjacent the outer circumferential surface thereof, said cam arm having a second end portion extending axially toward the other clutch member, said second arm portion containing a cam opening (126); and
(4) a cam follower pin (130) extending radially outwardly from the other clutch member into said cam opening;
(5) said cam opening being generally T-shaped and including;
(a) a first cam recess (126a) receiving said cam follower pin when said retaining arrangement is in said first condition; and
(b) second and third cam recesses (126b, 126c) contained in a plane axially displaced from said first cam recess, said second and third cam recesses being rotationally displaced relative to each other for receiving said cam follower pin when the rotational velocity of one output shaft exceeds that of the other output shaft above said given value.

14. A locking differential as defined in claim 13, wherein one of said clutch members has an outer circumferential surface containing a first external recess (122) within which said cam arm first end portion is secured, the other of said clutch members containing a corresponding second external recess (124) into which said second cam arm end portion extends, said cam follower pin being mounted in said second external recess.

15. A locking differential as defined in claim 14, and further including:
(i) a pair of annular spacer members (78, 80) having first ends that are arranged concentrically within counterbores contained in the remote ends of said clutch members, respectively, said spacer members having second ends that abut said side gears, respectively; and
(j) at least one spacer pin (82, 84) connecting each of said spacer members against rotation relative to the associated side gear, respectively.

16. A locking differential as defined in claim 15, wherein said friction drag device comprises:
(1) a pair of generally annular split friction rings (86, 88) concentrically mounted between said spacer members and the inner circumferential surfaces of the associated clutch members, respectively, each of said friction rings being radially biased outwardly toward frictional engagement with the associated clutch member; and
(2) at least one friction pin (90) connecting each of said friction rings against rotation relative to the associated spacer ring, said friction pin extending radially outwardly from the associated spacer member into the gap defined by the split contained in the associated friction ring;
(3) said friction rings having outer circumferential surfaces including external annular ribs (86a, 88a) that extend outwardly within corresponding annular grooves contained in the inner counterbore surfaces of clutch members, respectively.

17. A locking differential for an automotive vehicle having a drive shaft, and a pair of colinearly-arranged axially-spaced output shafts that drive the wheels of the vehicle, comprising:
(a) a cylindrical housing (H) adapted for rotation about a given axis of rotation, said housing containing a chamber having a pair of end walls containing a pair of aligned output shaft openings arranged coaxially with said axis of rotation for receiving the adjacent ends of said output shafts, respectively;
(b) a pair of annular axially-spaced side gears (164, 166) rotatably mounted in said chamber adjacent and collinear with said output shaft openings for non-rotatable splined connection with the output shafts, respectively, said side gears having adjacent spaced faces each provided with a circular arrangement of side gear teeth (212);
(c) a pair of axially-spaced annular clutch members (168, 170) arranged colinearly between said side gears, said clutch members having remote faces each including a circular arrangement of clutch teeth (210) opposite said side gear teeth, respectively, each of said clutch members being axially displaceable relative to the associated side gear between an engaged position in which said side gear and said clutch teeth are in engagement, and a disengaged position in which said side gear teeth and said clutch teeth are disengaged;
(d) a limit pin arrangement (202, 204, 206) affording limited relative angular rotational displacement between said clutch members;
(e) a spring arrangement (100) normally biasing said clutch members axially apart toward said engaged positions relative to said side gears, respectively;
(f) a drive pin (176) extending diametrically between said clutch members, said drive rod having a pair of end portions that extend within corresponding openings contained in said housing; said drive rod having an intermediate portion that extends within drive grooves (174) contained in the adjacent faces of said clutch members, the cross-sectional configuration of said drive grooves being such that when the rotational velocity of a first output shaft exceeds that of the other output shaft above a given value, the clutch member associated with the overrunning output shaft is axially displaced toward said disengaged position; and
(g) a holdout ring arrangement connected between each of said clutch members and the associated side gears for retaining the clutch member associated with the overrunning first output shaft in the disengaged position as long as the overrunning condition exists, said holdout ring arrangement including:
(1) a pair of annular resilient holdout rings (220, 222) mounted concentrically within each of said clutch members, respectively, each of said holdout rings containing throughout its length an axial slit (224);
(2) each said holdout ring being biased radially outwardly toward frictional engagement with the inner circumferential surface of the associated clutch member, thereby to define said friction drag means;
(3) said holdout rings including body portions having at their remote ends radially outwardly extending flange portions (220a, 222a) that extend within corresponding counterbores contained in the remote end surfaces of said clutch members, respectively; and
(4) a plurality of circumferentially-spaced locking lugs (226) mounted on and extending axially from the remote faces of said holdout ring flange portions;
(5) each of said holdout rings being angularly displaceable relative to the associated clutch member between a locking position in which said lugs extend between the teeth of the associated side gear when said clutch member and said side gear are in the engaged condition, and a retaining position in which the lugs engage the tips of the teeth of the associated side gear when said clutch member and said side gear are in the disengaged condition.

18. A locking differential as defined in claim 17, wherein the length of the teeth of said side gears is greater than the length of the clutch members, the teeth of said side gears extending radially inwardly to a greater extent than the teeth of the clutch members.

19. A locking differential as defined in claim 18, wherein said body portion of each of said holdout rings a plurality of axially extending slots (225) defining a plurality of body segments, said body segments being biased radially outwardly into engagement with the inner circumferential surface of the associated spacer member.

20. A locking differential as defined in claim 17, wherein the adjacent ends of said holdout rings contain a pair of diametrically arranged drive recesses that receive said drive rod.
